(19) United States
(12) Patent Application Publication
(10) Pub. No.: US 2024/0030738 A1
(43) Pub. Date: Jan. 25, 2024

(54) ELECTRONIC APPARATUS HAVING WIRELESS CHARGING FUNCTION, AND CONTROL METHOD THEREFOR

(71) Applicant: SAMSUNG ELECTRONICS CO., LTD., Suwon-si (KR)

(72) Inventors: Hyunku PARK, Suwon-si (KR); Jungoh SUNG, Suwon-si (KR); Juhyang LEE, Suwon-si (KR); Jeonggyu JO, Suwon-si (KR); Hyunju HONG, Suwon-si (KR); Woogeun KWAK, Suwon-si (KR); Jungsik PARK, Suwon-si (KR)

(73) Assignee: SAMSUNG ELECTRONICS CO., LTD., Suwon-si (KR)

(21) Appl. No.: 18/374,830

(22) Filed: Sep. 29, 2023

Related U.S. Application Data
(63) Continuation of application No. PCT/KR22/04409, filed on Mar. 29, 2022.

(30) Foreign Application Priority Data
Apr. 13, 2021 (KR) 10-2021-0047701

(51) Int. Cl. H02J 7/00

(52) U.S. Cl. CPC H02J 7/007194; H02J 7/00309; H02J 50/10

(57) ABSTRACT

An electronic device includes: a wireless charging circuit; at least one sensor; and at least one processor operatively connected to the wireless charging circuit and the at least one sensor. The at least one processor is configured to: perform charging using the wireless charging circuit; sense a temperature of the electronic device via the at least one sensor; control, based on the temperature of the electronic device, heat generation during the charging; and change a charging condition based on a charging duration time determined based on the heat controlled by the at least one processor.

### CROSS-REFERENCE TO RELATED APPLICATIONS

This application is a by-pass continuation application of International Application No. PCT/KR2022/004409, filed on Mar. 29, 2022, which is based on and claims priority to Korean Patent Application No. 10-2021-0047701, filed on Apr. 13, 2021, in the Korean Intellectual Property Office, the disclosures of which are incorporated by reference herein their entireties.

### BACKGROUND

### 1. Field

The disclosure relates to an electronic device having a wireless charging function and a control method thereof.

### 2. Description of Related Art

Electronic devices (e.g., a smartphone, a mobile terminal, a laptop, a tablet PC, or a wearable device) may provide various functions such as a voice communication function, a short-range wireless communication function, a mobile communication function, a photographing function, a content reproduction function, a navigation function, and the like.

As the performance of an electronic device has been improved, availability has been increased, and diversified functions have been provided, and a desire for high-speed charging or efficient power control has also been increased.

In the case of an electronic device that provides a wireless charging function, a battery may be charged via a wireless charging circuit without a wired connection. For example, the electronic device may charge a battery of the electronic device by using magnetic resonance or electromagnetic induction occurring between a power transmitting unit (PTU) and a wireless power receiving unit (PRU).

While wireless charging is performed, heat may be generated from an electronic device and the temperature of the electronic device may be increased. The electronic device may proceed with heat generation control for cooling in a period in which overheating occurs while wireless charging is performed. In case that the electronic device enters the heat generation control, charging may be blocked temporarily or a cooling period may be provided in which a charging power level is decreased. In case that the heat generation control is continued during the overheating state, a cooling period may become long or switching between a cooling period and a charging period may frequently occur.

In case that a cooling period is long or switching between a cooling period and a charging period frequently occurs, the total charging time spent for a full charge may be increased or the efficiency of wireless charging may be decreased.

In addition, in case that charging is continued at least a predetermined period of time, the electronic device generally becomes hot and heat generation is not easily dismissed, and thus the effect of heat generation control may be limited.

### SUMMARY

Provided are an electronic device having a wireless charging function that prevents a phenomenon in which a cooling period becomes long and switching between a cooling period and a charging period frequently occurs while wireless charging is performed, and a control method thereof.

In addition, provided are an electronic device having a wireless charging function that shortens the total charging time spent for a full charge or that improves the efficiency of wireless charging while wireless charging is performed, and a control method thereof.

According to an aspect of the disclosure, an electronic device includes: a wireless charging circuit; at least one sensor; and at least one processor operatively connected to the wireless charging circuit and the at least one sensor. The at least one processor is configured to: perform charging using the wireless charging circuit; sense a temperature of the electronic device via the at least one sensor; control, based on the temperature of the electronic device, heat generation during the charging; and change a charging condition based on a charging duration time determined based on the control of the heat generation.

The at least one processor may be further configured to change the charge condition based on (i) the charging duration time that is less than a threshold time or (ii) a number of times that the charging duration time is less than the threshold time, the number of times being greater than or equal to a reference number.

The charging condition may include a condition associated with at least one of a charging path, a charging power, a charging current, and a charging voltage.

The at least one processor may be further configured to change a charging path from a charging path including the wireless charging circuit to a normal charging path including a second wireless charging circuit.

The at least one processor may be further configured to decrease a charging power based on a state in which a charging path including the wireless charging circuit is maintained.

The at least one processor may be further configured to control the heat generation by using at least one of a charging power provided by the wireless charging circuit, a charging current, a charging voltage, and a charging interval.

During the heat controlled by the at least one processor, based on the temperature of the electronic device, which is greater than or equal to a threshold temperature, the at least one processor may be further configured to perform low-power charging by using the wireless charging circuit. Based on the temperature of the electronic device, which is less than the threshold temperature, the at least one processor may be further configured to perform high-power charging by using the wireless charging circuit.

The at least one processor may be further configured to change the charging condition based on at least one of a charging level and an elapsed charge time. Based on the charging level being greater than or equal to a reference ratio or the elapsed charge time being greater than or equal to a reference time, the at least one processor may be further configured to change the charging condition based on the charging duration time.

According to another aspect of the disclosure, a method performed by an electronic device, includes: performing charging; sensing a temperature of the electronic device; controlling, by an at least one processor, based on a temperature of the electronic device, heat generation during the charging; and changing a charging condition based on a charging duration time determined based on the heat controlled by the at least one processor.

The changing of the charging condition may include changing the charging condition based on the charging duration time being less than a threshold time or a number of times that the charging duration time being less than the threshold time. The number of times may be greater than or equal to a reference number.

The charging condition may include a condition associated with at least one of a charging path, a charging power, a charging current, and a charging voltage.

The changing of the charging condition may include changing a charging path from a high-speed charging path to a normal charging path.

The changing of the charging condition may include decreasing a charging power based on a state in which the charging path is maintained.

The controlling of the heat generation may include controlling the heat generation by using at least one of a charging power, a charging current, a charging voltage, and a charging interval.

According to one or more embodiments, a phenomenon in which a cooling period becomes long or switching between a cooling period and a charging period frequently occurs while wireless charging is performed may be prevented.

According to one or more embodiments, the total charging time spent for a full charge may be shortened or the efficiency of wireless charging may be improved while wireless charging is performed.

In addition, various effects directly or indirectly recognized from the document may be provided.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device according to an embodiment;

FIG. 2 is a block diagram of a charging circuit of an electronic device according to an embodiment;

FIG. 3 is a flowchart illustrating a wireless charging control method of an electronic device according to an embodiment;

FIG. 4 is a flowchart illustrating a wireless charging control method of an electronic device according to another embodiment;

FIG. 5 is a graph illustrating an example of a change in a charging state over time in an electronic device according to a comparative example;

FIG. 6 is a graph illustrating an example of a change in a charging state over time in an electronic device according to an embodiment; and

FIG. 7 is a block diagram illustrating an electronic device in a network environment according to one or more embodiments.

### DETAILED DESCRIPTION

Hereinafter, one or more embodiments will be described with reference to attached drawings.

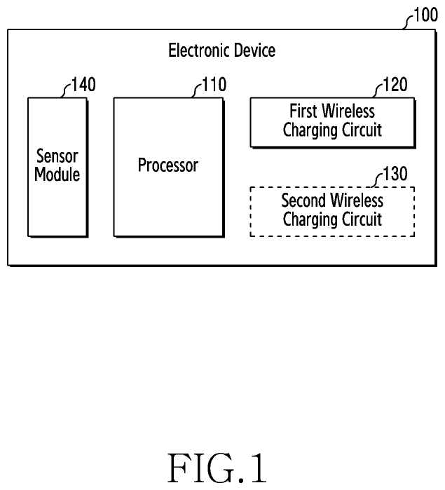

An electronic device according to one or more embodiments may have a wireless charging function. The structure or type of electronic device illustrated in FIG. 1, 2, or 7 may be merely an example, and the scope of embodiments is not limited to a predetermined structure or type of electronic device. The structure or type of electronic device illustrated in the document may be variously corrected, modified, or applied. The technical features described in the document are not limited to predetermined embodiments, and may be applied to every type of electronic device (e.g., a smartphone, a mobile terminal, a laptop, a tablet PC, a wearable device, or a battery charging device) that has a wireless charging function, includes a wirelessly chargeable battery, or is capable of electrically connecting to a wirelessly chargeable battery, and a wireless charging control method thereof.

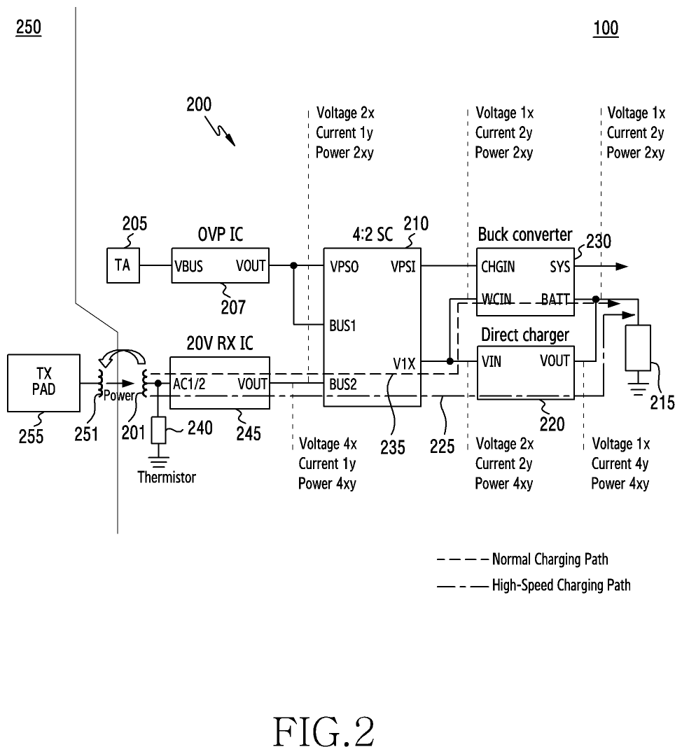

Hereinafter, for ease of description, one or more embodiments will be described with reference to an electronic device 100 of FIG. 1 and/or a charging circuit 200 of FIG. 2.

FIG. 1 is a block diagram of an electronic device according to an embodiment.

Referring to FIG. 1, the electronic device 100 according to an embodiment may include a processor 110, a sensor module 140, and a first wireless charging circuit 120. The electronic device 100 may further include a second wireless charging circuit 130.

The processor 110, the sensor module 140, the first wireless charging circuit 120, and the second wireless charging circuit 130 may be electrically and/or operatively connected to each other and may mutually exchange signals (e.g., a command signal or data).

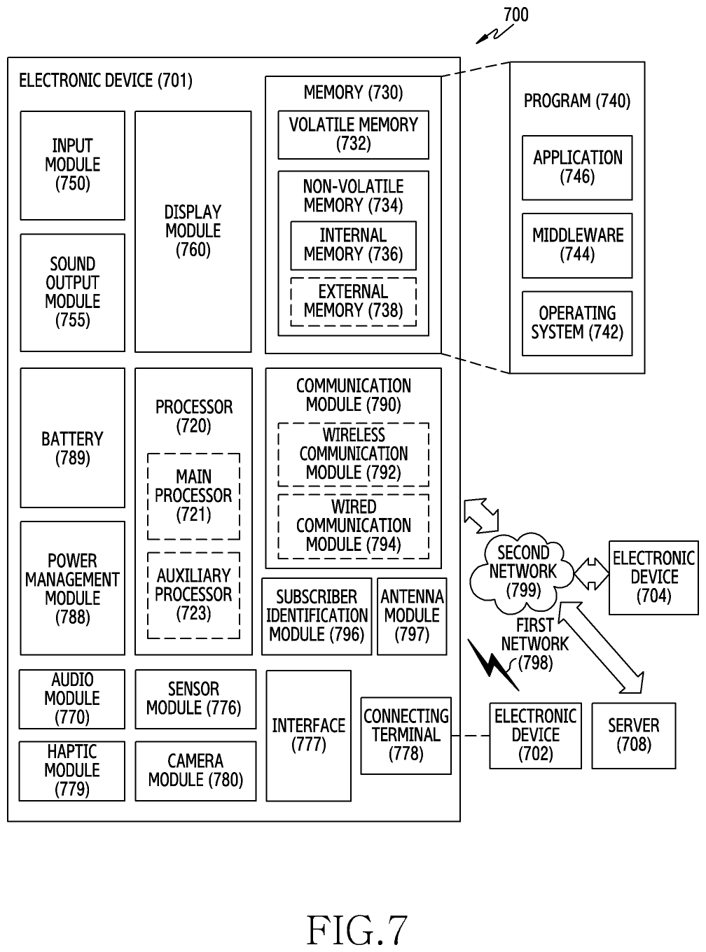

The electronic device 100 may correspond to an electronic device 701 illustrated in FIG. 7 or may include at least part of the electronic device 701 illustrated in FIG. 7 which is to be described later. For example, the processor 110 may correspond to a processor (one of processors 720 and 723) of FIG. 7. The processor 110 may include a power management module 788 of FIG. 7 or may electrically and/or operatively connected to the power management module 788. The first wireless charging circuit 120 and/or the second wireless charging circuit 130 may be included in the power management module 788 of FIG. 7 or may be operatively connected to the power management module 788. The sensor module 140 may correspond to a sensor module 776 of FIG. 7 or may include at least a part of the sensor module 776.

The electronic device 100 may provide a wireless charging function. The wireless charging function may include a high-speed charging function and/or a normal charging function. In some embodiments, the electronic device 100 may additionally provide a wired charging function.

The processor 110 may include at least one processor. For example, the processor 110 may include at least one of an application processor (AP) (e.g., a main processor 721), a communication processor (CP) (e.g., a sub-processor 823), or the power management module 788.

The processor 110 may perform and/or control various functions supported in the electronic device 100. The processor 110 may control at least part of the sensor module 140, the first wireless charging circuit 120, and the second wireless charging circuit 130.

The processor 110 may implement code written in a programing language stored in a memory (e.g., the memory 730 of FIG. 7) of the electronic device 100, thereby supporting a function, controlling various pieces of hardware, or performing an application. When instructions stored in the memory 730 are implemented, the processor 110 may perform operations or functions.

The processor 110 may provide a wireless charging function by controlling at least a part of the sensor module 140, the first wireless charging circuit 120, and the second wireless charging circuit 130.

The first wireless charging circuit 120 and the second wireless charging circuit 130 may be embodied separately, may be embodied in the form of sharing part of the circuits, or may be embodied in the form in which the whole or part of the circuits are integrated.

The electronic device 100 may include two types of wireless charging paths. For example, the electronic device 100 may include a high-speed charging path including the first wireless charging circuit 120 and a normal charging path including the second wireless charging circuit 130.

At least a part of the first wireless charging circuit 120 and at least a part of the second wireless charging circuit 130 may form charging paths different from each other. According to an embodiment, the first wireless charging circuit 120 may be included or disposed in a high-speed charging path. The second wireless charging circuit 130 may be included or disposed in a normal charging path.

The structures, dispositions, and/or signal flows of the first wireless charging circuit 120 and the second wireless charging circuit 130 for establishing different charging paths are not limited to the illustrated embodiment, and may be variously corrected, applied, modified, and/or extended.

For example, the first wireless charging circuit 120 and the second wireless charging circuit 130 may share part of circuits or may include part of circuits provided in an integrated form. For example, in case that the part of the circuits of the first wireless charging circuit 120 and the second wireless charging circuit 130 is embodied in an integrated form, a high-speed charging path and a normal charging path may equally include the part of the circuits provided in an integrated form.

As another example, the first wireless charging circuit 120 and the second wireless charging circuit 130 may be configured to share part of the circuits with each other, and to include other part of the circuits that are connected (or branched from the part of the circuits) to the part of the circuits so as to form independent signal paths, respectively.

As another example, the first wireless charging circuit 120 and the second wireless charging circuit 130 may include separate circuits to form independent charging paths, respectively.

According to an embodiment, the first wireless charging circuit 120 may include a circuit or high-speed charging (e.g., a direct charger). The first wireless charging circuit 120 may perform charging (e.g., high-speed charging) by using higher power than the second wireless charging circuit 130. For example, the first wireless charging circuit 120 may perform charging (e.g., high-speed charging) by using a charging voltage higher than that of the second wireless charging circuit 130 or by using a charging current higher than that of the second wireless charging circuit 130. The second wireless charging circuit 130 may include a circuit (e.g., a buck converter) for a normal charging.

The sensor module 140 may include at least one sensor. The sensor module 140 may sense the temperature of the electronic device 100, and may transfer the same to the processor 110. For example, the sensor module 140 may include a temperature sensor such as a thermistor, and may sense the temperature of the electronic device 100 via the temperature sensor.

The processor 110 may perform charging (e.g., high-speed charging) by using the first wireless charging circuit 120. The processor 110 may perform a normal charging by using the second wireless charging circuit 130. For example, the processor 110 may activate the first wireless charging circuit 120 among the two wireless charging circuits (the first wireless charging circuit 120 and the second wireless charging circuit 130), and may perform charging (e.g., high-speed charging) using the activated first wireless charging circuit 120. For example, the processor 110 may activate the second wireless charging circuit 130 among the two wireless charging circuits (the first wireless charging circuit 120 and the second wireless charging circuit 130), and may perform a normal charging using the activated second wireless charging circuit 130.

The processor 110 may sense the temperature of the electronic device 100 (e.g., a surface temperature, an internal temperature, a battery temperature, a measured temperature, an average temperature, or the peak temperature) via at least one sensor (e.g., a temperature sensor) included in the sensor module 140.

The processor 110 may control heat generation control based on the temperature of the electronic device 100 while high-speed charging is performed. The processor 110 may perform heat generation control by using at least one of charging power, a charging current, a charging voltage, and a charging interval.

For example, the processor 110 may determine whether the electronic device 100 is in a first overheating state based on the temperature of the electronic device 100. In case that the state is determined as the first overheating state, heat generation control may be performed.

While heat generation control is performed, in case that the temperature of the electronic device 100 falls within an overheating range (e.g., in case that the surface temperature of the electronic device 100 is greater than or equal to a threshold temperature (e.g., 40° C.)), low-power charging may be performed, and in case that the temperature of the electronic device 100 falls within a normal range (e.g., in case that the surface temperature of the electronic device 100 is less than the threshold temperature (e.g., 40° C.)), high-power charging may be performed.

For example, in case that the temperature of the electronic device 100 reaches a threshold temperature (e.g., in case that the surface temperature of the electronic device 100 is greater than or equal to a threshold temperature (e.g., 40° C.)), the processor 110 may decrease a charging current or a charging voltage for cooling, so as to decrease charging power. The threshold temperature may be a predetermined temperature configured in advance to determine whether overheating occurs. Via cooling, the temperature of the electronic device 100 may be decreased again to the threshold temperature, and the electronic device 100 may be restored to a normal state. In case that the temperature of the electronic device 100 is decreased to a threshold temperature (e.g., the surface temperature of the electronic device 100 is less than a threshold temperature (e.g., less than 40° C.)), the processor 110 may increase a charging current or a charging voltage, so as to increase charging power. Charging (e.g., high-speed charging) may be performed again using the increased charging power.

The processor 110 may change a charging condition based on a charging duration time based on the control of the heat generation. The processor 110 may obtain a charging duration time. For example, the processor 110 may measure or count a charging duration time. The processor 110 may change a charging condition based on a charging duration time. The charging duration time may be referred to as a charging maintaining time or a charging time.

For example, the processor 110 may determine whether the state is a second overheating state based on a charging duration time. In case that the state is determined as the second overheating state, the processor 110 may change a charging condition. The second overheating state may be understood as an excessive heat generation control state. In case that a cooling period becomes long or a cooling period is frequently provided due to excessive heat generation control, a charging duration time may be shortened and the total charging time may be delayed or the charging efficiency may be decreased.

In case that a charging condition is changed based on a charging duration time, excessive heat generation control may be prevented, and the total charging time may be shortened or charging efficiency may be improved.

For example, the processor 110 may change a charging condition in case that a charging duration time is less than a threshold time. As another example, the processor 110 may change a charging condition in case that the number of times that a charging duration time is less than a threshold time is greater than or equal to a reference number.

According to an embodiment, the charging condition may be a condition associated with at least one of a charging path, charging power, a charging current, and a charging voltage.

For example, a charging path may be changed (or switched) from a high-speed charging path (e.g., a high-speed charging path 225 of FIG. 2) to a normal charging path (e.g., a normal charging path 235 of FIG. 2). As another example, in the state in which the high-speed charging path 225 is maintained (e.g., maintained in an on-state or an activated state), charging power may be decreased (e.g., a charging current may be decreased by one level).

According to an embodiment, the processor 110 may change a charging condition by additionally considering or further based on at least one of a charging level and an elapsed charge time. A charging level may be a state of charge (SoC) or a charging ratio. For example, in case that the charging level is greater than or equal to a reference ratio or an elapsed charge time is greater than or equal to a reference time, the processor 110 may change a charging condition based on a charging duration time. The elapsed charge time may be a time elapsing after charging is initiated.

FIG. 2 is a block diagram of a charging circuit of an electronic device according to an embodiment. For example, wireless charging may be performed in the state in which the electronic device 100 that charges the battery 215 with wireless power supplied is in contact with or is close to an external electronic device 250 that is a supplier of wireless power. Wireless charging of the battery 215 in the electronic device 100 may be performed in the state in which the electronic device 100 embodied in the type of smartphone is in contact with one side (e.g., a side to which the wireless power transmission coil 251 is close) of the external electronic device 250 embodied in the type of wireless charging pad. The battery 215 may be inserted into (e.g., integrated with) the electronic device 100, may be detachably coupled to the electronic device 100, or may be operatively connected to the electronic device 100.

The electronic device 100 according to an embodiment may include a charging circuit 200 as illustrated in FIG. 2. For example, at least part (e.g., a wireless power reception circuit 245, a power distributer 210) of the charging circuit 200 may be controlled by the processor 110 of the electronic device 100.

The external electronic device 250 may include a wireless power transmission circuit 255 that is connected to a power source and supplies wireless power, and the wireless power transmission coil 251 that is configured to transmit wireless power supplied via the wireless power transmission circuit 255. For example, the wireless power transmission circuit 255 may be embodied in the type of transmission pad (TX PAD) for wireless charging.

The charging circuit 200 of the electronic device 100 may include component elements for providing a wireless charging function. The electronic device 100 may charge the battery 215 using wireless power supplied from the external electronic device 250. The charging circuit 200 may include a wireless power reception coil 201 configured to receive wireless power from the wireless power transmission coil 251, a thermistor 240 that operates as a temperature sensor, a wireless power reception circuit 245 operatively connected to the wireless power reception coil 201, the power distributor 210, a buck converter 230, and a direct charger 220.

For example, a charging mode of the electronic device 100 may include high-speed charging mode and a normal charging mode. One of the high-speed charging mode and the normal charging mode may be selected according to a predetermined charging mode or the present charging environment. For example, the high-speed charging mode may use at least part of the high-speed charging path 225, and the normal charging mode may use at least part of the normal charging path 235.

According to an embodiment, the charging circuit 200 of the electronic device 100 may include the normal charging path 235 and the high-speed charging path 225.

One of the high-speed charging path 225 and the normal charging path 235 may be selectively activated when wireless charging is performed. In case that the high-speed charging path 225 is activated and the normal charging path 235 is deactivated, high-speed charging (e.g., high-power charging) may be performed. In case that the normal charging path 235 is activated and the high-speed charging path 225 is deactivated, normal charging (e.g., low-power charging) may be performed.

The high-speed charging mode may require wireless power higher than that of the normal charging mode. The electronic device 100 may increase wireless power or may increase a reception voltage to reduce a resistance loss in the high-speed charging mode. For example, in case that a reception voltage (e.g., 4x=16V) which is 4 times higher than a battery charging voltage (e.g., x=4V) may be needed for performing high-speed charging. In order to increase the charging efficiency, a 4:1 programmable power supply (PPS) charging structure that uses the power distributor 210 and the direct charger 220 may be used.

The charging circuit 200 may include an element to selectively activate the high-speed charging path 225 and the normal charging path 235. For example, the high-speed charging path 225 or the normal charging path 235 may be selected via the power distributor 210 in the charging circuit 200. For example, the power distributor 210 may include an enable terminal. The electronic device 100 (e.g., the processor 110 of the electronic device 100) may activate/deactivate an enable terminal so as to select the high-speed charging path 225 or the normal charging path 235. In case that the high-speed charging path 225 is activated, the normal charging path 235 may be deactivated. In case that the normal charging path 235 is activated, the high-speed charging path 225 may be deactivated.

The high-speed charging path 225 may include at least part of a first wireless charging circuit (e.g., the first wireless charging circuit 120 of FIG. 1) for high-speed charging. The first wireless charging circuit may include the direct charger 220. In the high-speed charging path 225, the wireless power reception circuit 245→the power distributor 210→the direct charger 220→the battery 215 may be disposed. High-speed charging (e.g., high-power charging) may be enabled via the high-speed charging path 225. The direct charger 220 in the high-speed charging path 225 may perform charging (e.g., high-speed charging) by applying a higher power level (a voltage level and/or a current level) than that of the buck converter 230 in the normal charging path 235.

When the high-speed charging path 225 is activated, an output voltage of the wireless power reception circuit 245 may be approximately 4 times greater than the battery charging voltage (e.g., 4 times the battery charging voltage+offset). The output voltage of the wireless power reception circuit 245 may be input to the power distributor 210. A voltage may be converted to a half of the voltage and a current may be converted to 2 times the current via the power distributor 210 and may be output to the direct charger 220. The voltage may be converted to a half of the voltage and the current may be converted to 2 times the current via the direct charger 220 again, and may be output. For example, the direct charger 220 may increase a current level two times higher, so that high-speed charging may be enabled. For example, in case that a voltage is 4x (e.g., 16V), a current is 1y (e.g., 1.2 A), and power is 4xy (e.g., 19.2 W) in the output end (VOUT) of the wireless power reception circuit 245, a voltage is 2x (e.g., 8V), a current is 2y (e.g., 2.4 A), and power is 4xy (e.g., 19.2 W) in the input end (VIN) of the direct charger 220, and a voltage (or a charging voltage of the battery 215) is 1x (e.g., 4V), a current (a charging current of the battery 215) is 4y (e.g., 4.8 A), and power (or the charging power of the battery 215) is 4xy (e.g., 19.2 W) in the output end (VOUT) of the direct charger 220, as illustrated in the drawing.

The normal charging path 235 may include at least part of a second wireless charging circuit (e.g., the second wireless charging circuit 130 of FIG. 1) for a normal charging. The second wireless charging circuit may include the buck converter 230. In the normal charging path 235, the wireless power reception circuit 245→the power distributor 210→the buck converter 230→the battery 215 may be disposed. The wireless power reception circuit 245 may output a constant voltage, and the buck converter 230 may charge the battery 215 by adjusting a voltage and/or a current to a predetermined level. For example, the buck converter 230 may perform a normal charging by decreasing a power level (a voltage level and/or a current level). For example, the buck converter 230 may be embodied in the type of interface power management integrated circuit (IF PMIC) capable of configuring a power level.

In some embodiments, the charging circuit 200 of the electronic device 100 may further include component elements for providing a wired charging function by using a charging cable, for example, the wired charging adapter 205 (e.g., travel adapter (TA)) and/or an over voltage protection (OVP) circuit 207.

At least part of the component elements of the charging circuit 200, for example, the wireless power reception circuit 245, the power distributor 210, the first wireless charging circuit 120, the second wireless charging circuit 130, the wired charging adapter 205, or the OVP circuit 207 may be embodied independently or in the type of integrated circuit.

The wireless power reception circuit 245 may transmit a control signal to the external electronic device 250 or receive a control signal from the external electronic device 250 via the wireless power reception coil 201 under control performed by the processor 110.

The wireless power reception circuit 245 (e.g., 20V RX IC) may receive power from the wireless power transmission circuit 255 of the external electronic device 250. The wireless power reception circuit 245 may communicate with the external electronic device 250 via data communication (e.g., in-band and load modulation scheme-based communication), and may control wireless power transmitted from the external electronic device 250. For example, the wireless power reception circuit 245 may transmit a control signal to the external electronic device 250 so as to transmit power appropriate for a charging mode (e.g., a normal charging mode or a high-speed charging mode) of the electronic device 100. As another example, the wireless power reception circuit 245 may communicate with the external electronic device 250, and may perform power control (e.g., block power or switch to low power) for heat generation control or may block power in a full charge state.

The power distributor 210 (e.g., a 4:2 switched capacitor (SC) voltage divider) may be connected to the output end of the wireless power reception circuit 245 and the output end of the OVP circuit 207. The power distributor 210 may bypass or divide power and may output the same to a rear end.

The power distributor 210 may perform bypassing or distribution. For example, when performing bypassing, the power distributor 210 may not change and output the voltage of input power as it is. When performing distribution, the power distributor 210 may distribute the voltage of input power based on a predetermined ratio (e.g., 2:1), and may output the same. The whole power is maintained, and thus the current of the corresponding power may become double in case that the voltage of the power is distributed.

In the case that the normal charging path 235 is activated, the buck converter 230 may receive an output voltage (e.g., 10V) of the wireless power reception circuit 245 that the power distributer 210 bypasses, and may perform a normal charging. For example, in the case of the normal charging mode, the buck converter 230 may operate and may charge the battery 215 before entering the high-speed charging mode, in a constant voltage (CV) period, or in the situation of entering heat generation control (or a first overheating state). As another example, in the case of entering an excessive heat generation control state (or a second overheating state) while the direct charger 220 performs high-speed charging, the buck converter 230 may operate and charge the battery 215.

In the case that the high-speed charging path 225 is activated, the direct charger 220 may receive supply of an output voltage (e.g., 16V) of the wireless power reception circuit 245, and may perform charging (e.g., high-speed charging). For example, the direct charger 220 may receive input of an output voltage of the power distributor 210, may distribute the corresponding voltage based on a predetermined ratio (e.g., 2:1), and may charge the battery 215 using the distributed voltage.

The thermistor 240 may sense the temperature of the electronic device 100. For example, in order to satisfy a designated surface temperature restriction condition (e.g., 40° C. or less) while wireless charging is performed, the processor 110 may read the temperature of the thermistor 240 or may receive a temperature value from the thermistor 240. In case that the temperature of the thermistor 240 reaches a threshold temperature (e.g., 40° C.), a cooling period for decreasing a power level (a voltage and/or current) may be needed.

For example, the charging circuit 200 may charge the battery 215 via an electromagnetic induction scheme.

The wireless power reception coil 201 may produce an induced current for wireless charging, so as to perform wireless charging. The induced current for wireless charging may be produced by a change in the current of the wireless power transmission coil 251 of the external electronic device 250.

The external electronic device 250 may include the wireless power transmission coil 251.

The wireless power transmission coil 251 may produce a change in a current by using power from a power source and may produce an induced current for wireless charging based on a control signal received via the wireless power reception circuit 245 of the electronic device 100 or according to control performed by the wireless power transmission circuit 255 of the external electronic device 250 and/or a processor. Accordingly, the wireless power reception coil 201 of the electronic device 100 may produce an induced current for wireless charging, and may charge the battery 215 via the charging circuit 200.

The processor (e.g., the processor 110 of FIG. 1) of the external electronic device 250 may control, based on communication with the wireless power reception circuit 245 and/or processor 110 of the electronic device 100, the transmission power (e.g., a voltage and/or current) of the wireless power transmission coil 251.

The illustrated configuration of the charging circuit 200 is merely an example and is not limited to the scope of embodiments, and may be corrected, modified, or applied variously.

Although a wireless charging scheme using the principle of an electromagnetic induction has been described as an example, the principle of operating the wireless power transmission coil 251 and the wireless power reception coil 201 is not limited thereto, and operation may be performed by using a magnetic resonance scheme. In this instance, the wireless power reception coil 201 may be embodied to have a unique frequency that is the same as the frequency of magnetism produced from the wireless power transmission coil 251. The wireless power reception coil 201 may be connected to the wireless power reception circuit 245 and/or the processor 110, and may be controlled by the wireless power reception circuit 245 and/or the processor 110.

As another example, although the architecture in which the charging circuit 200 is embodied as a component element separate from the processor 110 and is controlled by the processor 110 has been described, at least part of the charging circuit 200 may be included in the processor 110 and may be embodied as a single component element depending on an embodiment.

As another example, although the architecture in which the wireless power reception coil 201 is embodied as a component element separate from the wireless power reception circuit 245 has been described, the wireless power reception circuit 245 may include the wireless power reception coil 201 and be embodied as a single component element depending on an embodiment.

As another example, although an example in which the wireless power transmission circuit 255 of the external electronic device 250 is embodied as a component element separate from the wireless power transmission coil 251, the wireless power transmission circuit 255 may include the wireless power transmission coil 251 and may be embodied as a single component element or the wireless power transmission circuit 255 may be included in a processor and may be embodied to control the wireless power transmission coil 251.

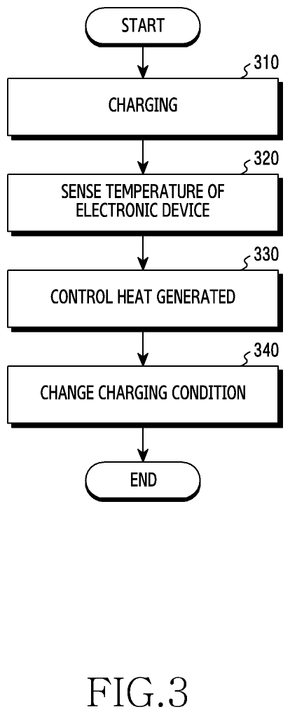

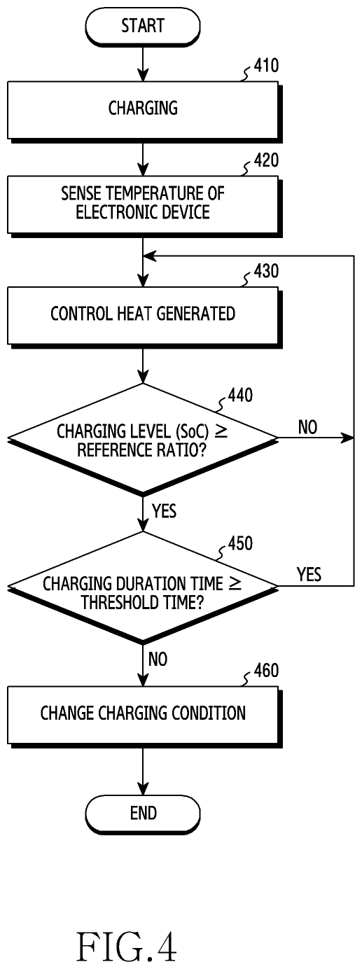

Hereinafter, with reference to FIGS. 3 and 4, a wireless charging control method of an electronic device according to one or more embodiments will be described with reference to FIGS. 3 and 4. Among the illustrated operations of the wireless charging control method, at least one of the operations may be omitted, the order of some operations may be changed, or another operation may be added. Alternatively, operations of each embodiment may be selectively combined and may be implemented.

A control method of an electronic device having a wireless charging function according to one or more embodiments may be performed by an electronic device (e.g., the electronic device 100 or the processor 110 of FIG. 1, the charging circuit 200 of FIG. 2, or the processor 720 of the electronic device 701 of FIG. 7). For ease of description, it is assumed that the wireless charging control method of the electronic device illustrated in FIGS. 3 and 4 is performed by the processor 110 of FIG. 1.

FIG. 3 is a flowchart illustrating a wireless charging control method of an electronic device according to an embodiment.

In operation 310, the processor 110 of the electronic device 100 may perform charging (e.g., high-speed charging). For example, the processor 110 may perform charging (e.g., high-speed charging) of the battery 215 via the high-speed charging path 225 including a first wireless charging circuit (e.g., the direct charger 220). According to a first charging condition (e.g., the high-speed charging path 225 and/or high power), the battery 215 of the electronic device 100 may be charged.

In operation 320, the processor 110 may sense the temperature of the electronic device 100. For example, the processor 110 may sense the temperature of the electronic device 100 (e.g., a surface temperature, an internal temperature, a battery temperature, a measured temperature, an average temperature, or the peak temperature) via the thermistor 240.

In operation 330, the processor 110 may control heat generation based on the temperature of the electronic device 100 while the high-speed charging is performed. While maintaining the high-speed charging path including the first wireless charging circuit 120, the processor 110 may perform heat generation control by using at least one of charging power supplied via the first wireless charging circuit 120, a charging current, a charging voltage, and a charging interval.

For example, the processor 110 may determine whether the electronic device 100 is in a first overheating state based on the temperature of the electronic device 100. In case that the state is determined as the first overheating state, heat generation control may be performed.

While heat generation control is performed, in case that the temperature of the electronic device 100 falls within an overheating range (e.g., in case that the surface temperature of the electronic device 100 is greater than or equal to a threshold temperature (e.g., 40° C.)), low-power charging may be performed by using the high-speed charging path 225, and in case that the temperature of the electronic device 100 falls within a normal range (e.g., in case that the surface temperature of the electronic device 100 is less than a threshold temperature (e.g., 40° C.)), high-power charging may be performed by using the high-speed charging path 225.

The heat generation control operation will be described in detail as follows.

According to an embodiment, in case that the temperature of the electronic device 100 is greater than or equal to a threshold temperature (e.g., in case that the surface temperature of the electronic device 100 is greater than or equal to 40° C.) while the high-speed charging is performed by using first charging power (high power), the processor 110 may decrease the first charging power to second charging power (low power) for cooling. In case that the temperature of the electronic device 100 is decreased to be lower than the threshold temperature via cooling (e.g., in case that the surface temperature of the electronic device 100 is less than 40° C.), the processor 110 may increase the second charging power again to the first charging power and may proceed with high-speed charging using the first charging power.

While heat generation control is performed, in case that the temperature of the electronic device 100 is greater than or equal to the threshold temperature (e.g., in case that the surface temperature of the electronic device 100 is greater than or equal to 40° C.), the processor 110 may decrease the charging power from the first charging power to the second charging power, and may proceed with charging using the second charging power. The second charging power may be lower than the first charging power. While heat generation control is performed, in case that the temperature of the electronic device 100 is less than the threshold temperature (e.g., in case that the surface temperature of the electronic device 100 is less than 40° C.), the processor 110 may increase the charging power to the first charging power again and may proceed with charging using the first charging power.

For example, in case that the temperature of the electronic device 100 reaches the threshold temperature (e.g., a surface temperature of 40° C.), the processor 110 may decrease a charging current or a charging voltage for cooling, so as to decrease charging power. The threshold temperature may be a predetermined temperature configured in advance to determine an overheating range. Via cooling, the temperature of the electronic device 100 may be decreased again to the threshold temperature, and the temperature is restored and falls within a normal range In case that the temperature of the electronic device 100 is decreased to the threshold temperature, the processor 110 may increase a charging current or a charging voltage again so as to increase charging power. Charging may be performed again using the increased charging power.

A charging duration time may be changed as heat generation control is performed. For example, as charging power (e.g., a charging current) supplied via the high-speed charging path 225 is changed for heat generation control in the state in which the high-speed charging path 225 is maintained, a charging period in which a charging power (e.g., a charging current) level is maintained and a cooling period in which a charging power (e.g., a charging current) level is dramatically decreased may be repeated. As charging is in progress, a cooling period may be frequently provided and a charging period may be gradually become short.

In operation 340, the processor 110 may change a charging condition based on a charging duration time based on the control of the heat generation. The processor 110 may obtain the charging duration time. For example, the processor 110 may measure or count the charging duration time. The processor 110 may change a charging condition based on the charging duration time. For example, the first charging condition (e.g., the high-speed charging path 225 or high power) may be changed to the second charging condition (e.g., the normal charging path 235 or low power). The battery 215 of the electronic device 100 may be charged according to the second charging condition.

For example, the processor 110 may determine whether the state is a second overheating state based on the charging duration time. The second overheating state may be an excessive heat generation control state. In case that a charging duration time is less than a threshold time or the number of times that a charging duration time is less than the threshold time is greater than or equal to a reference number, due to excessive heat generation control, this may be determined as the second overheating state.

In case that the state is determined as the second overheating state, the processor 110 may change a charging condition.

In case that a cooling period is repeatedly provided due to heat generation control, a charging duration time is shortened and the total charging time (e.g., a time spent for a full charge) may be delayed or the charging efficiency may be decreased.

In case that the charging condition is changed based on the charging duration time, excessive heat generation control may be prevented, and the total charging time may be shortened or charging efficiency may be improved.

For example, in case that the charging duration time is less than a threshold time (e.g., 1.5 minutes), the charging condition may be changed. As another example, in case that the number of times that the charging duration time is less than the threshold time is greater than or equal to a reference number (e.g., 5 times), the charging condition may be changed.

According to an embodiment, the charging condition may be a condition associated with at least one of a charging path, charging power, a charging current, and a charging voltage.

For example, the charging path may be changed from the high-speed charging path 225 including a first wireless charging circuit (e.g., the direct charger 220) to the normal charging path 235 including a second wireless charging circuit (e.g., the buck converter 230). In case that the charging path is changed, heat generation may be decreased, and thus the length of a cooling period or the number of times of entering a cooling period may be decreased. Accordingly, a charging speed may be increased and the total charging time (e.g., a full charge time) may be shortened. As another example, the charging power may be reduced (e.g., a charging current may be decreased by one level) in the state in which the high-speed charging path 225 is maintained. Similar to the case in which the charging path is change, in case that the charging power is decreased, heat generation may be decreased, and thus, the length of a cooling period or the number of times of entering a cooling period may be decreased. Accordingly, a charging speed may be increased and the total charging time (e.g., a full charge time) may be shortened.

FIG. 4 is a flowchart illustrating a wireless charging control method of an electronic device according to another embodiment.

For example, FIG. 4 corresponds to the case of controlling wireless charging based on a charging duration time and a charging level (or an elapsed charge time).

The processor 110 may change a charging condition by additionally considering or based on at least one of a charging level and an elapsed charge time. The charging level may be a state of charge (SoC). For example, in case that the charging level is greater than or equal to a reference ratio (e.g., 60%) or an elapsed charge time is greater than or equal to a reference time (e.g., 40 minutes), the processor 110 may change the charging condition based on a charging duration time.

Some operations of FIG. 4 may correspond to the operations of FIG. 3. For example, operation 410 may correspond to operation 310. Operation 420 may correspond to operation 320. Operation 430 may correspond to operation 330. Operation 460 may correspond to operation 340.

In operation 410, the processor 110 of the electronic device 100 may perform charging (e.g., high-speed charging). For example, the processor 110 may perform charging (e.g., high-speed charging) of the battery 215 via the high-speed charging path 225 including a first wireless charging circuit (e.g., the direct charger 220). For example, charging (e.g., high-speed charging) may be performed according to a first charging condition (e.g., the high-speed charging path 225, or a high voltage and/or a high current). The battery 215 of the electronic device 100 may be charged according to the first charging condition.

In operation 420, the processor 110 may sense the temperature of the electronic device 100. For example, the processor 110 may sense the temperature of the electronic device 100 (e.g., a surface temperature, an internal temperature, a battery temperature, a measured temperature, an average temperature, or the peak temperature) via the thermistor 240.

In operation 430, the processor 110 may control heat generation based on the temperature of the electronic device 100 while the high-speed charging is performed. The processor 110 may perform heat generation control by using at least one of charging power, a charging current, a charging voltage, and a charging interval.

For example, in the state in which the high-speed charging path 225 is maintained, in case that the temperature of the electronic device 100 falls within an overheating range (e.g., in case that the surface temperature of the electronic device 100 is greater than or equal to a threshold temperature (e.g., 40° C.)), the processor 110 may perform heat generation control by decreasing charging power (a current and/or a voltage) for cooling, and in case that the temperature is beyond the overheating range (e.g., in case that the surface temperature of the electronic device 100 is less than the threshold temperature (e.g., 40° C.), the processor 110 may perform heat generation control by increasing the charging power (a current and/or voltage) by one level so as to be restored to original charging power.

For example, the processor 110 may determine whether the electronic device 100 is in a first overheating state based on the temperature of the electronic device 100. In case that the state is determined as the first overheating state, heat generation control may be performed.

While heat generation control is performed, in case that the temperature of the electronic device 100 falls within an overheating range (e.g., in case that the surface temperature of the electronic device 00 is greater than or equal to a threshold temperature (e.g., 40° C.)), low-power charging may be performed, and in case that the temperature of the electronic device 100 falls within a normal range (e.g., in case that the surface temperature of the electronic device 100 is less than the threshold temperature (e.g., 40° C.)), high-power charging may be performed.

In operation 440, the processor 110 may determine whether a charging level (or a state of charge) of the battery 215 is greater than or equal to a reference ratio (e.g., 60%). Alternatively, although not illustrated, the processor 110 may determine whether an elapsed charge time is greater than or equal to a reference time (e.g., 40 minutes). For example, in case that the charging level is greater than or equal to the reference ratio (e.g., Yes in operation 440) and/or in case that an elapsed charge time is greater than or equal to the reference time, it is determined that the possibility of entering the second overheating state is high.

In case that the charging level is greater than or equal to the reference ratio (Yes in operation 440) and/or the elapsed charge time is greater than or equal to the reference time, operation 450 may be performed.

In case that the charging level is less than the reference ratio (No in operation 440) and/or the elapsed charge time is less than the reference time, the high-speed charging may be maintained without changing the charging condition. The heat generation control based on the temperature of the electronic device 100 may be performed while the high-speed charging is performed.

In operations 450 and 460, the processor 110 may change the charging condition based on a charging duration time.

In operation 450, the processor 110 may determine whether the charging duration time is greater than or equal to a threshold time.

In operation 450, the processor 110 may determine whether the charging duration time is greater than or equal to the threshold time. In case that the charging duration time is greater than or equal to the threshold time (Yes in operation 450), the high-speed charging may be maintained without changing the charging condition. Heat generation control may be performed based on the temperature while the high-speed charging is performed.

In case that the charging duration time is less than the threshold time (e.g., 1.5 minutes) or the number of times that the charging duration time is less than the threshold time is greater than or equal to a reference time (e.g., 5 times) (No in operation 450), operation 460 may be performed.

In operation 460, the processor 110 may change the charging condition. For example, the first charging condition (e.g., the high-speed charging path 225 and/or high power) may be changed to the second charging condition (e.g., the normal charging path 235 and/or low power). The battery 215 of the electronic device 100 may be charged according to the second charging condition.

For example, the processor 110 may determine whether the state is a second overheating state based on the charging duration time. In case that the state is determined as the second overheating state, the processor 110 may change the charging condition. The second overheating state may be an excessive heat generation control state. In case that the charging condition is changed based on the charging duration time, excessive heat generation control may be prevented, and thus the total charging time may be shortened or charging efficiency may be improved.

For example, in case that the charging duration time is less than the threshold time (e.g., 1.5 minutes), the charging condition may be changed. As another example, in case that the number of times that the charging duration time is less than the threshold time is greater than or equal to a reference number (e.g., 5 times), the charging condition may be changed.

According to an embodiment, the charging condition may be a condition associated with at least one of a charging path, charging power, a charging current, and a charging voltage.

For example, the charging path may be changed from the high-speed charging path 225 including a first wireless charging circuit (e.g., the direct charger 220) to the normal charging path 235 including a second wireless charging circuit (e.g., the buck converter 230). As another example, charging power may be reduced (e.g., a charging current may be decreased by one level) in the state in which the high-speed charging path 225 is maintained.

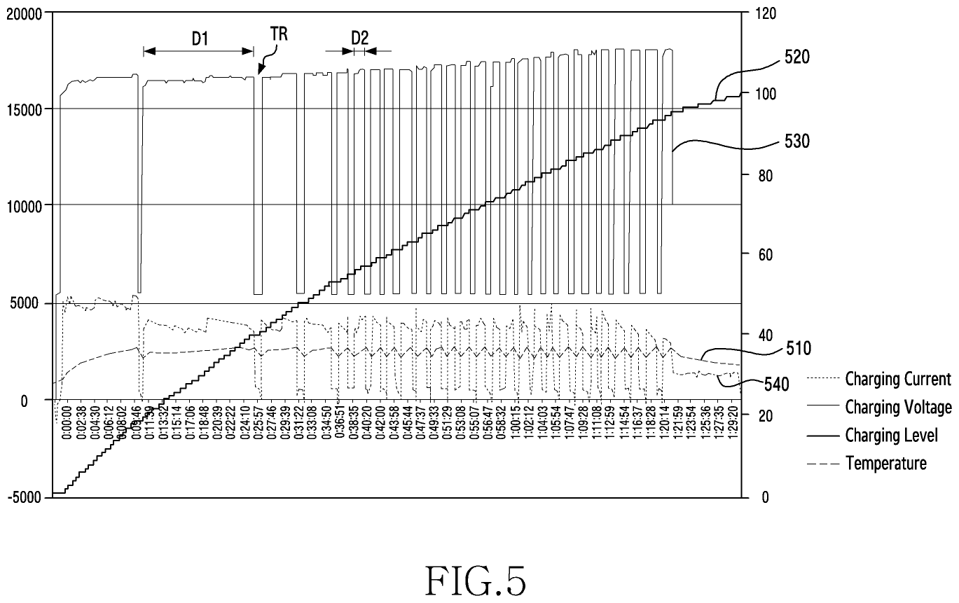

FIG. 5 is a graph illustrating an example of a change in a charging state over time in an electronic device according to a comparative example.

As the temperature of the electronic device is increased after charging begins, heat generation control may be performed in order to decrease the temperature of the electronic device.

In the example of FIG. 5, numbers in the X-axis refer to charging times. Numbers in the Y-axis of one side refer to charging voltages. Numbers in the Y-axis of the other side refer to charging levels. Reference numeral 510 refers to a change in the temperature of the electronic device. Reference numeral 520 refers to a change in a charging level. Reference numeral 530 refers to a change in a charging voltage. Reference numeral 540 refers to a change in a charging current.

In the example of FIG. 5, reference numeral D1 may be a first period. The first period (D1) may be a charging duration time of an initial stage (non-overheating state). A TR may be a heat generation control point. D2 may be a second period. The second period (D2) may be a charging duration time after the initial stage (overheating state).

The electronic device may perform heat generation control for cooling while charging is performed. For example, while heat generation control is performed, in case that the surface temperature of the electronic device reaches a predetermined temperature, the electronic device may decrease a charging current or a charging voltage or may block charging for cooling. In case that the temperature of the electronic device is decreased again to a predetermined temperature via cooling, the electronic device may increase a charging voltage or a charging current or may resume charging.

As charging is performed, the electronic device generally becomes hot and charging heat generation becomes difficult to be spread out more and more, and thus an excessive heat generation control period may be provided. In an excessive heat generation control period, a cooling period may be long or may be frequently provided, and a charging duration time may be shortened gradually. In the excessive heat generation control period, a phenomenon that continues charging during a significantly short period (e.g., a second period (D2)) when compared to the initial stage (e.g., the first period (D1)) and enters a cooling period for heat generation control is repeated, and thus the total period of time spent for a full charge may become long or the charging efficiency may be decreased.

According to one or more embodiments, by changing the charging condition based on the charging duration time, a phenomenon in which a cooling period for heat generation control is significantly long or a cooling period is frequently performed, and the total charging time is delayed and a charging efficiency is decreased, may be prevented.

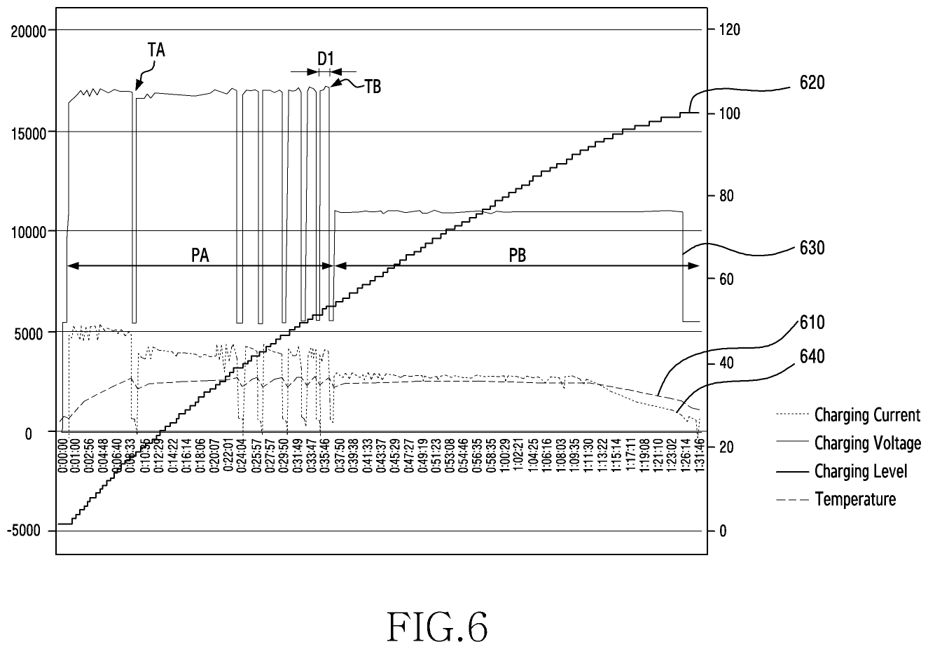

FIG. 6 is a graph illustrating an example of a change in a charging state over time in an electronic device according to an embodiment.

In the example of FIG. 6, numbers in the X-axis refers to charging times. Numbers in the Y-axis refer to charging voltages. Numbers in the Y-axis of the other side refer to charging levels. Reference numeral 610 refers to a change in the temperature of the electronic device 100. Reference numeral 620 refers to a change in the charging level of the battery 215. Reference numeral 630 refers to a change in the charging voltage of the battery 215. Reference numeral 640 refers to a change in the charging current of the battery 215.

In the example of FIG. 6, reference numeral D1 may be a charging duration time (or a charging period). A TA may be a primary heat generation control point. A TB may be a charging condition changing point. A PA may be a first period. In the first period (PA), charging (e.g., high-speed charging) may be performed according to a first charging condition. A PB may be a second period. In the second period (PB), a charging may be performed according to a second charging condition. For example, the second charging condition may be obtained by changing a charging path or charging power (a charging voltage and/or charging current) according to the first charging condition. For example, charging (e.g., high-speed charging) may be performed by using a high-speed charging path (e.g., the direct charger 220) in the first period (PA), and a normal charging may be performed by using a normal charging path (e.g., the buck converter 230) in the second period (PB). As another example, charging (e.g., high-speed charging) may be performed by using a first charging current in the first period (PA), and a normal charging may be performed by using a second charging current lower than the first charging current in the second period (PB).

Based on the temperature of the electronic device 100, a heat generation control point may be identified. For example, a primary heat generation control point (TA) may be the point at which the temperature (e.g., the surface temperature) of the electronic device 100 is dropped to be less than a threshold temperature (e.g., 40° C.). In the case of heat generation control, the electronic device 100 may temporarily block charging or may decrease charging power (a voltage and/or current) for cooling. For example, the electronic device 100 may decrease a charging current by one level at the primary heat generation control point (TA) for cooling while high-speed charging is performed.

A charging duration time (e.g., D1) may be a period of time during which high-speed charging is maintained.

By performing heat generation control, an event in which a charging duration time (e.g., D1) is decreased to be less than a threshold time (e.g., 1.5 minutes) or an event in which the number of times that the charging duration time (e.g., D1) is less than the threshold time is greater than or equal to a reference number may occur.

The electronic device 100 may change the first charging condition to the second charging condition based on a charging duration time based on the control of the heat generation. In case that the charging duration time (e.g., D1) is less than a threshold time (in case that high-speed charging is maintained during a short time (e.g., 1.5 minutes)) or the number of times that the charging duration time (e.g., D1) is less than the threshold time is greater than or equal to a reference number, the electronic device 100 may recognize that the electronic device 100 enters an excessive heat generation control state and may change a charging condition. For example, the electronic device 100 may change a charging path or may decrease charging power (a voltage and/or a current).

Accordingly, although the charging power is decreased, the length of a cooling period or the number of times of entering a cooling period is decreased, and a charging duration time may become long. In addition, by preventing excessive heat generation control, the total charging time may be reduced or the charging efficiency may be increased. For example, by comparing simulation results of FIG. 5 and FIG. 6, the total charging time spent for a full charge may be reduced by approximately 6 to 20 minutes.

High-power charging may further strengthen the improvement such as shortening of a charging time and increasing of the charging efficiency. For example, in case that charging power is not high, an excessive heat generation period may not be present. In this instance, a charging duration time may be always longer than a time spent for cooling. Conversely, in the case of high-power charging (e.g., 15 W to 20 W quick charging), charging power is high, and thus there is a high possibility of existence of an excessive heat generation period in which a charging duration time is short and a time spent for cooling is long. In this instance, by preventing excessive heat generation control via wireless charging control based on a charging duration time, the improvement of shortening the total charging time or increasing the charging efficiency may be remarkably provided.

FIG. 7 is a block diagram illustrating an electronic device 701 in a network environment 700 according to one or more embodiments. Referring to FIG. 7, the electronic device 701 in the network environment 700 may communicate with an electronic device 702 via a first network 798 (e.g., a short-range wireless communication network), or at least one of an electronic device 704 or a server 708 via a second network 799 (e.g., a long-range wireless communication network). According to an embodiment, the electronic device 701 may communicate with the electronic device 704 via the server 708. According to an embodiment, the electronic device 701 may include a processor 720, memory 730, an input module 750, a sound output module 755, a display module 760, an audio module 770, a sensor module 776, an interface 777, a connecting terminal 778, a haptic module 779, a camera module 780, a power management module 788, a battery 789, a communication module 790, a subscriber identification module (SIM) 796, or an antenna module 797. In some embodiments, at least one of the components (e.g., the connecting terminal 778) may be omitted from the electronic device 701, or one or more other components may be added in the electronic device 701. In some embodiments, some of the components (e.g., the sensor module 776, the camera module 780, or the antenna module 797) may be implemented as a single component (e.g., the display module 760).

The processor 720 may execute, for example, software (e.g., a program 740) to control at least one other component (e.g., a hardware or software component) of the electronic device 701 coupled with the processor 720, and may perform various data processing or computation. According to one embodiment, as at least part of the data processing or computation, the processor 720 may store a command or data received from another component (e.g., the sensor module 776 or the communication module 790) in volatile memory 732, process the command or the data stored in the volatile memory 732, and store resulting data in non-volatile memory 734. According to an embodiment, the processor 720 may include a main processor 721 (e.g., a central processing unit (CPU) or an application processor (AP)), or an auxiliary processor 723 (e.g., a graphics processing unit (GPU), a neural processing unit (NPU), an image signal processor (ISP), a sensor hub processor, or a communication processor (CP)) that is operable independently from, or in conjunction with, the main processor 721. For example, when the electronic device 701 includes the main processor 721 and the auxiliary processor 723, the auxiliary processor 723 may be adapted to consume less power than the main processor 721, or to be specific to a specified function. The auxiliary processor 723 may be implemented as separate from, or as part of the main processor 721.

The auxiliary processor 723 may control at least some of functions or states related to at least one component (e.g., the display module 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). According to an embodiment, the auxiliary processor 723 (e.g., an image signal processor or a communication processor) may be implemented as part of another component (e.g., the camera module 780 or the communication module 790) functionally related to the auxiliary processor 723. According to an embodiment, the auxiliary processor 723 (e.g., the neural processing unit) may include a hardware structure specified for artificial intelligence model processing. An artificial intelligence model may be generated by machine learning. Such learning may be performed, e.g., by the electronic device 701 where the artificial intelligence is performed or via a separate server (e.g., the server 708). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734.

The program 740 may be stored in the memory 730 as software, and may include, for example, an operating system (OS) 742, middleware 744, or an application 746.

The input module 750 may receive a command or data to be used by another component (e.g., the processor 720) of the electronic device 701, from the outside (e.g., a user) of the electronic device 701. The input module 750 may include, for example, a microphone, a mouse, a keyboard, a key (e.g., a button), or a digital pen (e.g., a stylus pen).

The sound output module 755 may output sound signals to the outside of the electronic device 701. The sound output module 755 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 760 may visually provide information to the outside (e.g., a user) of the electronic device 701. The display module 760 may include, for example, a display, a hologram device, or a projector and control circuitry to control a corresponding one of the display, hologram device, and projector. According to an embodiment, the display module 760 may include a touch sensor adapted to detect a touch, or a pressure sensor adapted to measure the intensity of force incurred by the touch.

The audio module 770 may convert a sound into an electrical signal and vice versa. According to an embodiment, the audio module 770 may obtain the sound via the input module 750, or output the sound via the sound output module 755 or a headphone of an external electronic device (e.g., an electronic device 702) directly (e.g., wiredly) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. According to an embodiment, the sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device (e.g., the electronic device 702) directly (e.g., wiredly) or wirelessly. According to an embodiment, the interface 777 may include, for example, a high definition multimedia interface (HDMI), a universal serial bus (USB) interface, a secure digital (SD) card interface, or an audio interface.

A connecting terminal 778 may include a connector via which the electronic device 701 may be physically connected with the external electronic device (e.g., the electronic device 702). According to an embodiment, the connecting terminal 778 may include, for example, a HDMI connector, a USB connector, a SD card connector, or an audio connector (e.g., a headphone connector).

The haptic module 779 may convert an electrical signal into a mechanical stimulus (e.g., a vibration or a movement) or electrical stimulus which may be recognized by a user via his tactile sensation or kinesthetic sensation. According to an embodiment, the haptic module 779 may include, for example, a motor, a piezoelectric element, or an electric stimulator.

The camera module 780 may capture a still image or moving images. According to an embodiment, the camera module 780 may include one or more lenses, image sensors, image signal processors, or flashes.

The power management module 788 may manage power supplied to the electronic device 701. According to one embodiment, the power management module 788 may be implemented as at least part of, for example, a power management integrated circuit (PMIC).

The battery 789 may supply power to at least one component of the electronic device 701. According to an embodiment, the battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the application processor (AP)) and supports a direct (e.g., wired) communication or a wireless communication. According to an embodiment, the communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as Bluetooth™, wireless-fidelity (Wi-Fi) direct, or infrared data association (IrDA)) or the second network 799 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 792 may identify and authenticate the electronic device 701 in a communication network, such as the first network 798 or the second network 799, using subscriber information (e.g., international mobile subscriber identity (IMSI)) stored in the SIM 796.

The wireless communication module 792 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 792 may support a high-frequency band (e.g., the mmWave band) to achieve, e.g., a high data transmission rate. The wireless communication module 792 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 792 may support various requirements specified in the electronic device 701, an external electronic device (e.g., the electronic device 704), or a network system (e.g., the second network 799). According to an embodiment, the wireless communication module 792 may support a peak data rate (e.g., 20 Gbps or more) for implementing eMBB, loss coverage (e.g., 764 dB or less) for implementing mMTC, or U-plane latency (e.g., 0.5 ms or less for each of downlink (DL) and uplink (UL), or a round trip of 7 ms or less) for implementing URLLC.

The antenna module 797 may transmit or receive a signal or power to or from the outside (e.g., the external electronic device) of the electronic device 701. According to an embodiment, the antenna module 797 may include an antenna including a radiating element composed of a conductive material or a conductive pattern formed in or on a substrate (e.g., a printed circuit board (PCB)). According to an embodiment, the antenna module 797 may include a plurality of antennas (e.g., array antennas). In such a case, at least one antenna appropriate for a communication scheme used in the communication network, such as the first network 798 or the second network 799, may be selected, for example, by the communication module 790 (e.g., the wireless communication module 792) from the plurality of antennas. The signal or the power may then be transmitted or received between the communication module 790 and the external electronic device via the selected at least one antenna. According to an embodiment, another component (e.g., a radio frequency integrated circuit (RFIC)) other than the radiating element may be additionally formed as part of the antenna module 797.

According to one or more embodiments, the antenna module 797 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 701 and the external electronic device 704 via the server 708 coupled with the second network 799. Each of the electronic devices 702 or 704 may be a device of a same type as, or a different type, from the electronic device 701. According to an embodiment, all or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 701. The electronic device 701 may provide the outcome, with or without further processing of the outcome, as at least part of a reply to the request. To that end, a cloud computing, distributed computing, mobile edge computing (MEC), or client-server computing technology may be used, for example. The electronic device 701 may provide ultra-low-latency services using, e.g., distributed computing or mobile edge computing. In another embodiment, the external electronic device 704 may include an internet-of-things (IoT) device. The server 708 may be an intelligent server using machine learning and/or a neural network. According to an embodiment, the external electronic device 704 or the server 708 may be included in the second network 799. The electronic device 701 may be applied to intelligent services (e.g., smart home, smart city, smart car, or healthcare) based on 5G communication technology or IoT-related technology.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that one or more embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

One or more embodiments as set forth herein may be implemented as software (e.g., the program 740) including one or more instructions that are stored in a storage medium (e.g., internal memory 736 or external memory 738) that is readable by a machine (e.g., the electronic device 701). For example, a processor (e.g., the processor 720) of the machine (e.g., the electronic device 701) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

An electronic device (e.g., the electronic device 100 of FIG. 1) according to one or more embodiments may include a wireless charging circuit for high-speed charging (e.g., at least part of the first wireless charging circuit 120 of FIG. 1 or the high-speed charging path 225 of FIG. 2), at least one sensor (e.g., the sensor module 140 of FIG. 1 or the thermistor 240 of FIG. 2), and at least one processor (e.g., the processor 110 of FIG. 1) operatively connected to the wireless charging circuit and the at least one sensor. The at least one processor is configured to perform charging (e.g., high-speed charging) using the wireless charging circuit, to sense a temperature of the electronic device via the at least one sensor, to control, based on the temperature of the electronic device, heat generation during the high-speed charging, and to change a charging condition based on a charging duration time determined based on the heat controlled by the at least one processor.

According to one or more embodiments, the charging condition may be changed based on the charging duration time that is less than a threshold time.

According to one or more embodiments, the charging condition may be changed based on a number of times that the charging duration time is less than the threshold time. The number of times may be greater than or equal to a reference number.

According to one or more embodiments, the charging condition may include a condition associated with at least one of a charging path, charging power, a charging current, and a charging voltage.

According to one or more embodiments, a charging path may be changed from a high-speed charging path (e.g., the high-speed charging path 225 of FIG. 2) including the wireless charging circuit to a normal charging path (e.g., the normal charging path 235 of FIG. 2) including a second wireless charging circuit.

According to one or more embodiments, charging power may be decreased in the state in which a high-speed charging path including the wireless charging circuit is maintained.

According to one or more embodiments, heat generation may be controlled by using at least one of charging power provided by the wireless charging circuit, a charging current, a charging voltage, and a charging interval.

According to one or more embodiments, during the control of the heat generation, based on the temperature of the electronic device, which is greater than or equal to a threshold temperature, low-power charging may be performed by using the wireless charging circuit. Based on the temperature of the electronic device, which is less than the threshold temperature, high-power charging may be performed by using the wireless charging circuit.

According to one or more embodiments, the at least one processor may be configured to change the charging condition by additionally considering or based on at least one of a charging level and an elapsed charge time.

According to one or more embodiments, based on the charging level being greater than or equal to a reference ratio or the elapsed charge time being greater than or equal to a reference time, the charging condition may be changed based on the charging duration time.

According to one or more embodiments, a wireless charging control method of an electronic device may include an operation of performing high-speed charging, an operation of sensing a temperature of the electronic device, an operation of controlling, based on a temperature of the electronic device, heat generation during the high-speed charging, and an operation of changing a charging condition based on a charging duration time determined based on the heat controlled by the at least one processor.

According to one or more embodiments, the charging condition may be changed based on the charging duration time that is less than a threshold time.

According to one or more embodiments, the charging condition may be changed based on the number of times that the charging duration time that is less than the threshold time. The number of times may be greater than or equal to a reference number.

According to one or more embodiments, the charging condition may include a condition associated with at least one of a charging path, charging power, a charging current, and a charging voltage.

According to one or more embodiments, a charging path may be changed from a high-speed charging path to a normal charging path.

According to one or more embodiments, charging power may be decreased in the state in which the high-speed charging path is maintained.

According to one or more embodiments, heat generation may be controlled by using at least one of charging power, a charging current, a charging voltage, and a charging interval.

According to one or more embodiments, during the control of the heat generation, based on the temperature of the electronic device, which is greater than or equal to a threshold temperature, low-power charging may be performed by using a high-speed charging path, and based on the temperature of the electronic device, which is less than the threshold temperature, high-power charging may be performed by using the high-speed charging path.

According to one or more embodiments, a charging condition may be changed by considering or based on at least one of a charging level and an elapsed charge time.

According to one or more embodiments, based on the charging level being greater than or equal to a reference ratio or the elapsed charge time being greater than or equal to a reference time, the charging condition may be changed based on the charging duration time.

What is claimed is:

1. An electronic device comprising:
a wireless charging circuit;
at least one sensor; and
at least one processor operatively connected to the wireless charging circuit and the at least one sensor,
wherein the at least one processor is configured to:
perform charging using the wireless charging circuit;
sense a temperature of the electronic device via the at least one sensor;
control, based on the temperature of the electronic device, heat generation during the charging; and
change a charging condition based on a charging duration time based on the control of the heat generation.

2. The electronic device of claim 1, wherein the at least one processor is further configured to change the charging condition based on the charging duration time being less than a threshold time or a number of times that the charging duration time is less than the threshold time being greater than or equal to a reference number.

3. The electronic device of claim 1, wherein the charging condition comprises a condition associated with at least one of a charging path, a charging power, a charging current, and a charging voltage.

4. The electronic device of claim 1, wherein the at least one processor is further configured to change the charging condition by changing a charging path from a charging path comprising the wireless charging circuit to a normal charging path comprising a second wireless charging circuit.

5. The electronic device of claim 1, wherein the at least one processor is further configured to change the charging condition by decreasing a charging power based on a state in which a charging path comprising the wireless charging circuit is maintained.

6. The electronic device of claim 1, wherein the at least one processor is further configured to control the heat generation by using at least one of a charging power provided by the wireless charging circuit, a charging current, a charging voltage, and a charging interval.

7. The electronic device of claim 1, wherein, during the control of the heat generation, based on the temperature of the electronic device being greater than or equal to a threshold temperature, low-power charging is performed by using the wireless charging circuit, and
based on the temperature of the electronic device being less than the threshold temperature, high-power charging is performed by using the wireless charging circuit.

8. The electronic device of claim 1, wherein the at least one processor is further configured to change the charging condition further based on at least one of a charging level and an elapsed charge time.

9. The electronic device of claim 8, wherein the at least one processor is further configured to, based on the charging level being greater than or equal to a reference ratio or the elapsed charge time being greater than or equal to a reference time, change the charging condition based on the charging duration time.

10. A method performed by an electronic device, the method comprising:
performing charging;
sensing a temperature of the electronic device;
controlling, based on a temperature of the electronic device, heat generation during the charging; and
changing a charging condition based on a charging duration time based on the controlling of the heat generation.

11. The method of claim 10, wherein the changing of the charging condition comprises changing the charging condition based on the charging duration time being less than a threshold time or a number of times that the charging duration time is less than the threshold time being greater than or equal to a reference number.

12. The method of claim 10, wherein the charging condition comprises a condition associated with at least one of a charging path, a charging power, a charging current, and a charging voltage.

13. The method of claim 10, wherein the changing of the charging condition comprises changing a charging path from a high-speed charging path to a normal charging path.

14. The method of claim 10, wherein the changing of the charging condition comprises decreasing a charging power based on a state in which the charging path is maintained.

15. The method of claim 10, wherein the controlling of the heat generation comprises controlling the heat generation by using at least one of a charging power, a charging current, a charging voltage, and a charging interval.
